(19) United States
(12) Patent Application Publication
(10) Pub. No.: US 2002/0112319 A1
(43) Pub. Date: Aug. 22, 2002

(54) Hinge

(76) Inventor: Makoto Kida, Yokohama city (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/079,070

(22) Filed: Feb. 20, 2002

(30) Foreign Application Priority Data
Feb. 21, 2001 (JP) 2001-094312
Aug. 28, 2001 (JP) 2001-258325
Nov. 8, 2001 (JP) 2001-343212

(51) Int. Cl. E05C 17/64

(52) U.S. Cl. 16/342

(57) ABSTRACT

In the present invention, the transverse cross-section shape of a lubricant oil groove of a frictional resin body is formed to have a V shape where a lubricant oil is pooled and an oil film necessary to the smooth rotation of a rotation metal shaft is readily and positively formed and it is possible to prevent a breakage of the frictional resin body.

### CROSS-REFERENCE TO RELATED APPLICATIONS

This application is based upon and claims the benefit of priority from the prior Japanese Patent Applications No. 2001-094312, filed Feb. 21, 2001, No. 2001-258325, filed Aug. 28, 2001; and No. 2001-343212, filed Nov. 8, 2001, the entire contents of all of which are incorporated herein by reference.

### BACKGROUND OF THE INVENTION

1. Field of the Invention

The present invention relates to a hinge of such a structure as to pivotally support a rotation shaft by a frictional body and to a hinge for pivotally supporting a liquid crystal monitor-mounted top cover, etc., on a device such as a notebook size personal computer.

2. Description of the Related Art

In recent years, the device such as a personal computer has been becoming handy in carrying it about and has been becoming smaller and smaller in size and lighter and lighter in weight.

The top cover with a liquid crystal display section mounted thereon in the notebook sized personal computer is pivotally supported by a hinge on the notebook sized personal computer body. In this case, it is necessary for the hinge to be able to freely open and close the top cover relative to the computer body and, also, have the locking function of locking the top cover to any rotation position.

Recently, use has been made of a larger screen device to make a liquid crystal display section easier to view. The increasing tendency has been toward adopting a heavier top cover so as to mount it on the personal computer. Under these situations, a larger sized hinge structure for pivotally supporting the top cover has been used so as to increase a cover retaining capability, thus providing a bar to obtaining a compact and lightweight unit.

A proposal has been made in Jpn. Pat. Appln. KOKAI Publication No. 2000-356214 to provide a compact hinge structure having the above-mentioned function without sacrificing a compact and lightweight device.

This hinge is of such a bearing type that a rotation metal shaft is pivotally supported by a frictional resin body. That is, its bearing friction body is comprised of a molded resin product (article) having a tapered configuration. A rotation metal shaft having a tapered shape is fitted into the frictional resin body. A nut is threaded over a threaded portion of the rotation shaft. By pressing the rotation shaft into the frictional resin body, the rotation metal shaft is press-fitted in the frictional resin body.

Since, here, the rotation metal shaft is press-fitted in the frictional resin body, too strong a resistance acts when the rotation metal shaft is rotated, there being a risk that a “locking” phenomenon will occur in the rotation shaft. In order to avoid this “locking”, four to eight grease grooves (T) are provided in the mating surface of a frictional resin body (A) to the rotation metal shaft as shown in FIG. 14 to seal the grease in the grease groove. By doing so, a grease film in created between the rotation metal shaft (B) and the frictional resin body (A).

In this conventional hinge structure, the transverse cross-section shape of the grease groove (T) in the frictional resin body (A) is formed to have a square shape of a relatively narrow width as shown in FIG. 14. The tapered peripheral surface of the rotation metal shaft (B) is tightly press-fitted in the tapered inner surface of the frictional resin body (A). The inner surface of the frictional resin body (A) is frictionally rubbed by a rotating metal shaft (B) while being strongly pressed. As a result, an opening edge portion of the grease groove (T) in the inner surface of the frictional resin body (A) is collapsed upon being pressed by the tapered peripheral surface of the rotation metal shaft (B) and is deformed as shown in FIG. 15. For this reason, the opening of the grease groove (T) was sometimes blocked.

If, in this way, the opening of the grease groove (T) is blocked, then the grease in the grease groove (T) does not flow out of the grease groove, thus preventing the formation of a locking-preventing grease film which is to be formed between the frictional resin body (A) and the rotation metal shaft (B). The formation of the grease film, being inadequate, causes the “seizure” of the rotation metal shaft onto the frictional resin body (A) when the rotation metal shaft (B) is rotated. If this occurs, there is a risk that the rotation of the rotation metal shaft will not be produced and that the frictional resin body (A) will break.

In the conventional hinge, a resin molded product has its tapered inner hole press-fitted over the tapered portion of the rotation metal shaft to provide a required frictional rotation force. For this reason, it is important to secure the durability of the frictional resin body. Since, in particular, the frictional body of the resin molded product become weak upon being exposed to high temperature, if the resin product is left for a longer period of time, for example, in a car in the summer season and exposed to high temperature under a hot atmosphere in the car, then the frictional body of the resin-molded product is deteriorated, thus lowering its strength and hence failing to maintain a frictional rotation force.

There is sometimes the case that no requisite frictional rotation force will be maintained due to the deterioration and weakening of the frictional body in the resin molded product and the consequent lowering of a reaction force under a tightening force. If this occurs, there arises the problem such that a top cover with a liquid crystal display section attached thereto is not locked to a desired position.

### BRIEF SUMMARY OF THE INVENTION

The object of the present invention is to provide a hinge which can secure a smooth rotation operation for a longer time period while ensuring a given feeling of resistance.

The present invention provides a hinge which pivotally supports a rotation shaft in a bearing hole of a frictional body while ensuring a given feeling of resistance, the hinge comprising a frictional resin body having a bearing hole having a tapered inner surface; a rotation shaft having a tapered peripheral surface press-fitted into the bearing hole of the frictional body; a tightening tool by which the tapered peripheral surface of the rotation shaft is press-fitted in the inner surface of the bearing hole; and lubricant oil grooves formed in the inner surface of the bearing hole of the frictional body into which the tapered peripheral surface of the rotation shaft is pressed and allowing a lubricant oil to be pooled therein, the lubricant oil groove having such a shape that, even when the inner surface of the bearing hole receives a pressing force from the rotation shaft, an opening of the lubricant oil groove is not blocked, in which the lubricant oil from the lubricant oil groove is supplied between the inner surface of the bearing hole and the peripheral surface of the rotation shaft to form a lubricant oil film therebetween and the rotation shaft is press-fitted into the bearing hole of the frictional body and pivotally supported while ensuring a feeling of resistance at the rotation of the rotation shaft.

The present invention provides a hinge in which a frictional resin body having a tapered bearing hole is supported on a bearing body, a rotation shaft has its tapered peripheral surface fitted into the corresponding bearing hole of the frictional resin body, a tightening means is provided according to which a nut is threaded over a threaded portion of the rotation shaft to cause the tapered peripheral surface of the rotation shaft to be press-fitted in the tapered inner surface of the bearing hole of the frictional resin body, while ensuring a feeling of required rotation resistance, and a spring member such as a seat spring is interposed between a member on the frictional resin body side and a member on a nut side and the spring member is elastically squeezed and tightened.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a vertical cross-sectional view showing a hinge according to a first embodiment of the present invention;

FIG. 2 is a perspective view showing a bearing body and a metal collar, in an exploded state, in the hinge according to the first embodiment of the present invention;

FIG. 3 is a vertical cross-sectional view showing a frictional resin body in the hinge according to the first embodiment of the present invention;

FIG. 4 is a transverse cross-sectional view showing a rotation metal shaft and frictional resin body, in an assembled state, in the hinge according to the first embodiment of the present invention;

FIG. 5 is a transverse cross-sectional view showing a rotation metal shaft and a frictional resin body, in an assembled state, in a hinge according to a second embodiment of the present invention;

FIG. 6 is a vertical cross-sectional view showing a frictional resin body in a hinge according to a third embodiment of the present invention;

FIG. 7 is a vertical cross-sectional view showing a frictional resin body in a hinge according to a fourth embodiment of the present invention;

FIG. 8 is a vertical cross-sectional view showing a frictional resin body in a hinge according to a fifth embodiment of the present invention;

FIG. 9 is a vertical cross-sectional view showing a state just before a completion of assembling of a hinge according to a sixth embodiment of the present invention;

FIG. 10 is a vertical cross-sectional view showing the hinge according to the sixth embodiment of the present invention;

FIG. 11 is a perspective view showing a disk spring in the hinge according to the sixth embodiment of the present invention;

FIG. 12 is a vertical cross-sectional view showing an array of disk springs in the hinge according to the sixth embodiment of the present invention;

FIG. 13A is a vertical cross-sectional view showing a spring member in the hinge according to the present invention;

FIG. 13B is a side view showing a spring member in the hinge according to the present invention;

FIG. 13C is a front view showing a spring member in the hinge according to the present invention;

FIG. 14 is a transverse cross-sectional view showing an assembled state of a rotation metal shaft and frictional resin body in the hinge; and

FIG. 15 is a cross-sectional view showing an assembled state of a rotation metal shaft and frictional resin body in which a grease pooled groove is collapsed under pressure from the rotation metal shaft.

### DETAILED DESCRIPTION OF THE INVENTION

(First Embodiment)

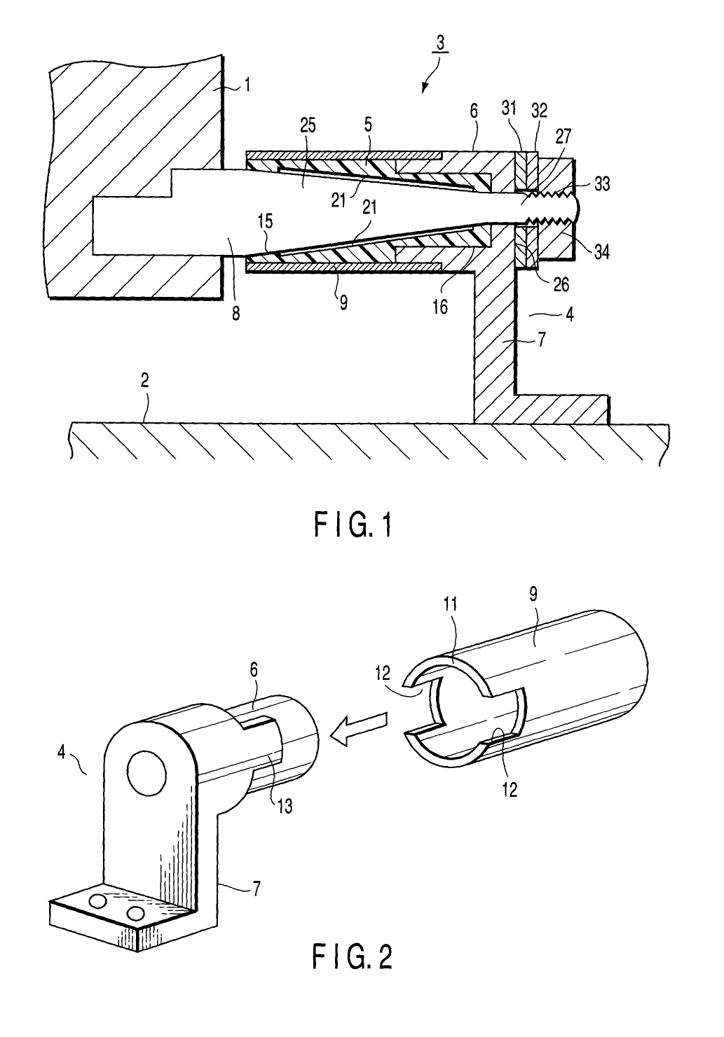

A hinge according to a first embodiment of the present invention will be explained below with reference to FIGS. 1 to 4. In the present embodiment, a practical hinge 3 is provided by which a top cover 1 of a notebook sized personal computer is pivotally supported on a personal computer body 2.

A bearing body 4 of the hinge 3 is one piece molded with the use of a zinc die-casting product and comprises a cylindrical retaining section 6 for retaining a frictional resin body 5 as will be set out below and a leg section 7 fixing the bearing body 4 to the personal computer body 2. A rotation shaft 8 made of a metal is fitted into the frictional body 5 to fixedly support the top cover 1 as a rotation member. The rotation shaft is made of iron, such as stainless steel.

A cylindrically formed metal collar 9 is tightly fitted over an outer periphery of a projecting portion of the frictional body 5 which extends from the retaining section 6. The metal collar 9 is so fitted as to prevent a base portion 11 shown in FIG. 2 from being rotated relative to the outer periphery of the end edge portion of the retaining section 6. As shown in FIG. 2, a plurality of latching cutouts 12 are formed in the base portion of the metal collar 9. On the other hand, a plurality of latching projections 13 are provided relative to the outer peripheral portion of the retaining section 6 so as to correspond to the latching cutouts 12. When the metal collar 9 is fitted over the outer peripheral portion of the retaining section 6, the respective outputs 12 are mated to the corresponding latching projections 13 to prevent the rotation of the metal collar 9. It is preferable that, when the metal collar 9 is fitted over the outer peripheral portion of the retaining section 6, the metal collar 9 be fixed to the outer peripheral portion of the retaining section 6 by means of bonding, welding, etc.

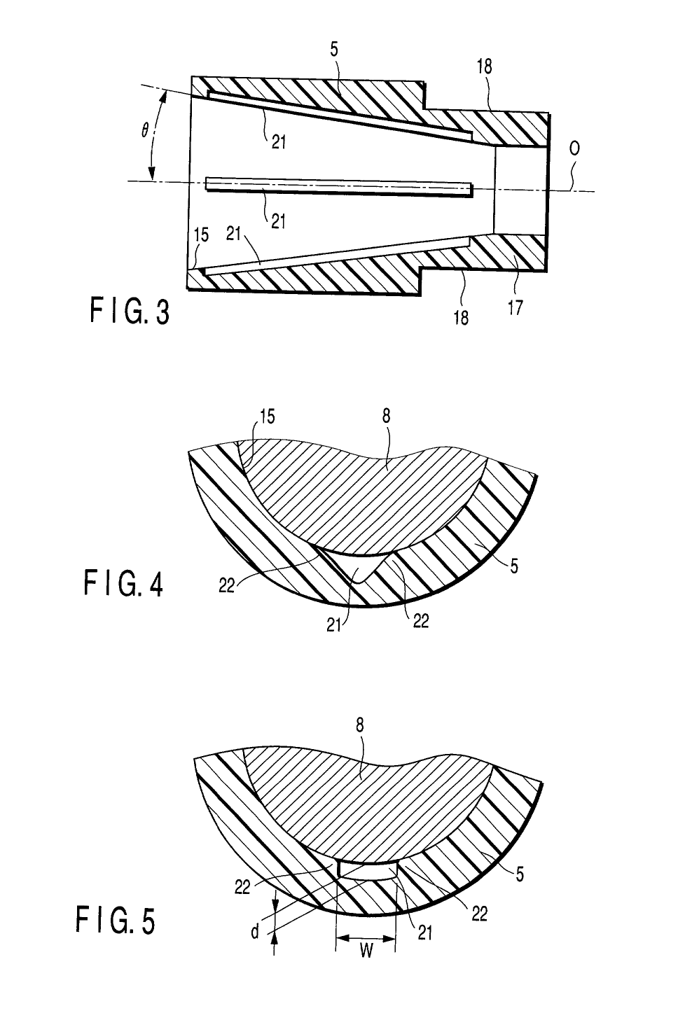

Further, the frictional body 5 is comprised of a cylindrical resin molded product and formed with a bearing hole 15 of a tapered configuration. As the material of the frictional body 5 there are, for example, polycarbonate materials. It is preferred that the frictional body 5 be molded with the use of polycarbonate molding materials having their own restoring force, in particular, upon receiving an external pressure force. As shown in FIG. 3, the tapering angle 2θ of the bearing hole 15 is about 10° to 25° and, preferably, 14°.

The frictional body 5 has its base end portion 17 fitted into a hole 16 in the retaining section 6 of the bearing body 4 and is retained such that the frictional body 5 is not rotated relative to the bearing body 4. The outer peripheral portion of the base portion 17 of the frictional body 5 is formed not with a circular peripheral surface but with a different-shaped surface such as at least a partly flattered surface 18. On the other hand, the inner hole 16 of the retaining section 6, into which the different-shaped base end portion 17 of the frictional body 5 is fitted, is so configured as to engage the flattened surface 18 as set out above.

As shown in FIG. 1, the base end portion 17 of the frictional body 5 has a reduced diameter section smaller in diameter than a projection end section 19 extending from the inner hole 16 of the retaining section 6. The metal collar 9 is tightly fitted on the outer periphery of the projection end portion 19 of the frictional body 5.

A plurality of grease grooves 21 are formed in the tapered inner surface of the bearing hole 15 of the frictional body 5. The grease groove allowing the grease to be pooled therein is situated as an elongated groove parallel to a center line 0 of the frictional body 5 as shown in FIG. 3. The transverse cross-sectional shape of the grease groove 21 is a substantially V shape as shown in FIG. 4. Respective angular portions 22 of the opening of the V-shaped grease groove 21, that is, respective end edges of the opening, are radiused to provide a small R.

In the grease groove 21 a grease is pooled as a lubricant. The grease groove 21 is so situated as to be restricted within a tapered inner surface area of the bearing hole 15 in the frictional body 5 making contact with the tapered peripheral surface of the rotation shaft 8. If, in this way, the grease groove 21 is located without extending through the area of the tapered inner surface of the bearing hole 15, then an added grease retention capability is insured so that it is possible to prevent a waste leakage of the grease. Further, it is also possible to prevent a lowering in the strength of the frictional body 5 resulting from the formation of grease grooves 21.

On one hand, a tapered type outer peripheral surface 25 conforming to the tapered inner surface of the bearing hole 15 is formed also on the peripheral surface portion of the rotation shaft 8 fitted into the frictional body 5. Such a structure is of a type that the tapered peripheral surface of the rotation metal shaft 8 is inserted into the tapered bearing hole 15 of the frictional body 5 and, by a means of a later-described tightening means, the tapered peripheral surface of the rotation metal shaft 8 is pressed into contact with the tapered inner surface of the bearing hole 15.

As shown in FIG. 1, one end of the rotation shaft 8 extends from the frictional body 5 onto the retaining section 6 of the bearing body 4 and further extends out of a rear surface 26 of the retaining section 6. On that extending end portion 27 a washer 31 and washer 32 are fitted, the washer 31 being used to prevent a damage to a body and the washer 32 being used to prevent a rotation. The washers 31 and 32 are made of a plate-like metal but these washers may be made of a relatively strong and hard resin.

A threaded section 33 is formed on a forward end portion 27 of the rotation metal shaft 8 and a nut is threaded as a tightening tool to the threaded section 33. By threading the nut 34 to the threaded section 33 the rotation shaft 8 is drawn toward the nut 34 side to allow the tapered peripheral surface of the rotation shaft 8 to be brought into pressure contact with the tapered inner surface of the bearing hole 15. The washers 31 and 32 are tightened under a reaction force at that time. The washer 31 is pressed onto a rear surface 26 of the retaining section 6. The washer 32 is pushed against the tightening nut 34 and serves as a unit integral with the rotation shaft 8. The washer 31 may be integrally coupled to the retaining section 6 by means of a latching means not shown and the washer 32 also may be coupled to the fastening nut 34 by means of a latching means not shown. The washers 31 and 32 are brought into sliding contact with each other to allow a rotation action of the rotation shaft 8.

In this embodiment, the frictional resin body 5 is fitted over the rotation shaft 8 and these are so assembled together as shown in FIG. 1 and, further, the rotation metal shaft 8 is tightened by means of the nut 34. At this time, a tightened force is imparted through the tapered peripheral surface of the rotation metal shaft 8 to the frictional body 5, thus generating a stress trying to allow the frictional body 5 to expand to an outside. Though the frictional body 5 itself tries to expand toward an outside, the metal collar 9 fitted over the outer periphery of the frictional body 5 prevents an elongation of the frictional resin body 5 and blocks an escape of the tightening force. The tightening force of the frictional body 5 stopped by the metal collar 9 becomes a reaction force without being escaped, thus generating a pressure contact action in the rotation metal shaft 8.

The frictional resin body 5, though being compact by itself, generates a stronger elastic action in its solid state and functions as an elastic body, though being slight in thickness, producing an adequate springing effect. At a sliding rotation under a wedge action under which the tapering surfaces of the frictional body 5 and rotation shaft 8 are fitted together, a required resistance is generated in the rotation shaft 8.

Here, the grease sealed in the grease groove 21 penetrates between the frictional body 5 and the rotation shaft 8 to create a grease film between the frictional body 5 and the rotation shaft 8. Even if, therefore, press fitting occurs between the frictional body 5 and the rotation shaft 8, no hard fitting is produced between the frictional body 5 and the rotation shaft 8, so that the rotation shaft 8 is not prevented from its normal rotation. Therefore, there is no possibility that a resistance at the rotation of the rotation shaft 8 will become too strong and that the rotation shaft will be locked into an inoperative state. For example, under a resistance force of 7 kg/mm it is possible to easily secure a required feeling of resistance and, at the same time, it is possible to provide a function of locking the rotation shaft 8 to any rotated position. It is, therefore, possible to ensure a normal operation and also to obtain a feeling of resistance under a constant resistance condition.

Further, the operation of assembling the frictional resin body 5 into the bearing body 4 can be replaced by a plugging method. In this case, it is possible to lower an assembling cost and obtain a compact device less in its component parts, lighter in weight and in cost and excellent in its outer appearance.

Since, on one hand, the rotation metal shaft 8 is strongly tightened by the nut 34 so as to obtain a required feeling of resistance between the frictional resin body 5 and the rotation resistance 8, the rotation shaft 8 imparts a forceful pressure to the inner surface of the frictional resin body 5, thus trying to deform the opening edge of the grease groove 21 where the grease is pooled. As shown in FIG. 4, however, the grease groove is substantially V-shaped in cross section and the opening portion of the grease groove is hard to collapse. Even if the edge portion of the grease groove is somewhat collapsed, its shape avoids the situation in which the opening of the grease groove is deformed to block the opening. The grease groove 21 is radiused at its respective angular portions 22 of the opening, that is, at the respective end edges of the opening, to provide a hard-to-collapse shape.

It may be said that, instead of providing such radiused portions, angular portions of the groove's opening are removed at its straight section. The transverse cross-section of the grease groove 21 may take a somewhat trapezoidal V-shaped form with a somewhat some bottom width, not a typical V-shaped form with a narrowed bottom, in which case it is also effective.

As set out above, the shape of the grease groove 21 of this invention is hard to collapse at its opening edges even if it is pressed by the rotation shaft and, even if being somewhat collapsed, the opening of the grease groove is not blocked thereby.

(Second Embodiment)

A hinge according to a second embodiment of the present invention will be described below with reference to FIG. 5. In this embodiment, the cross-sectional shape of a grease groove 21 is different from that of the first embodiment. That is, as shown in FIG. 5, the cross-sectional shape of the grease groove 21 takes a somewhat rectangular form of W>H where W indicates the opening width of the grease groove and H indicates the depth of the grease groove. The remaining structure of this embodiment is similar to that of the first embodiment. It is particularly desired that the ratio of W to H be 1.5 to 3, or 1.5≦W/H≦3.

According to this embodiment, even if the edge of the grease groove 21 is deformed when the inner surface of the bearing hole of a frictional resin body 5 receives a pressing force from a rotation shaft 8, it avoids the situation in which the opening of the grease groove 21 is blocked. That is, the transverse cross-sectional shape of the grease groove 21 of this embodiment takes a form by which the opening of the grease groove 21 is not blocked.

(Third Embodiment)

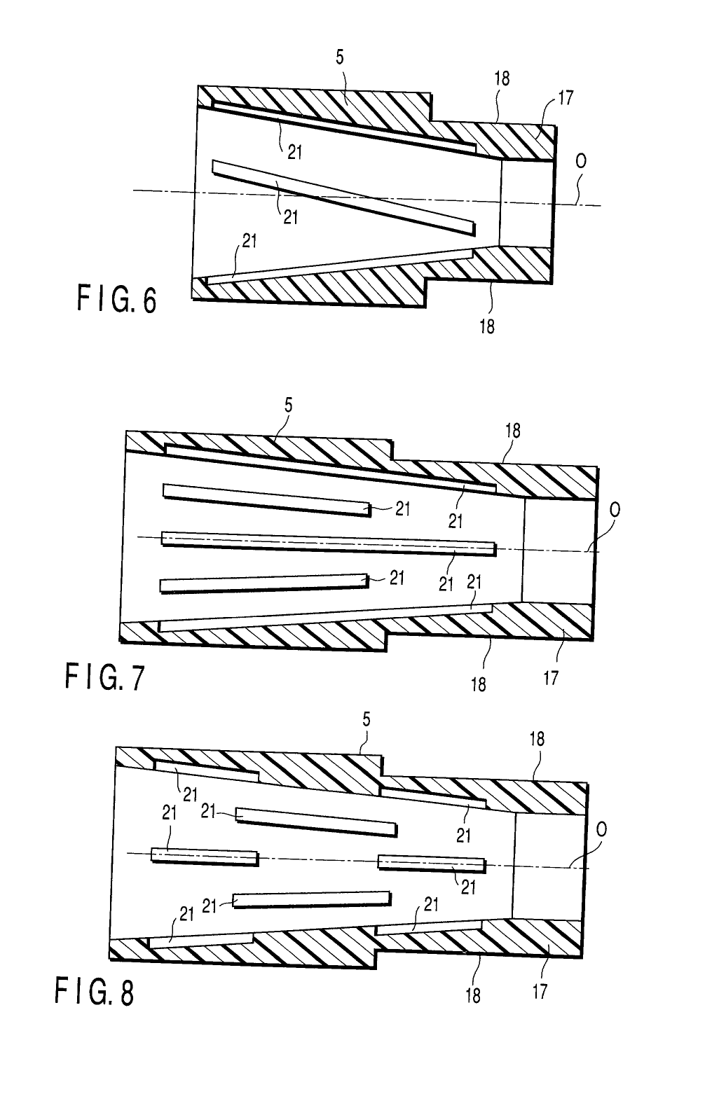

A hinge according to a third embodiment of the present invention will be described below with reference to FIG. 6. In this embodiment, grease grooves 21 for allowing a grease to be pooled therein are provided at an acute angle relative to a center line O of a frictional resin body 5. If the grease grooves 21 are so located at such an acute angle relative to the center line O of the frictional resin body 5, the resultant structure has the function and advantage as will be set out below.

The frictional resin body 5 is one-piece molded in general by a molding technique and, if a tapered peripheral surface of a rotation metal shaft 8 is pushed into a hole of the frictional resin body 5, then such a pushing force acts as a radial force passing through the center line O of the frictional resin body 5. Such forces act as forces tending to expand the frictional resin body 5 radially.

Where, here, as shown in FIG. 3, grease grooves 21 are provided along the center line O as in the case of the first embodiment, the resin body 5 has its wall thickness reduced along the whole length of each grease groove 21, so that a corresponding portion reduces its strength. Since such strength-reduced grooves are formed along a direction parallel to the center line O, if the rotation metal shaft 8 is tightly pressed into the hole of the resin body 5, there is a risk that the resin body 5 will be broken along the grease grooves 21.

Where a weaker feeling of resistance may be used as a required resistance, it does not matter if the grease grooves 21 may be provided along the direction parallel to the center line O as in the case of the first embodiment.

If, however, the grease grooves 21 are provided at the oblique angle relative to the center line O of the frictional resin body as in the case of this embodiment, then a radial expansion force acts only on a portion of each grease groove 21 to provide an added strength. As a result, there is no risk that the resin body 5 will be broken. This embodiment is suitable, in particular, to obtaining a stronger feeling of resistance as a required resistance.

From the above reason, it is desirable to set a 45° angle relative to the center line O as an acute angle of the grease grooves 21 relative to the center line O of the resin body 5.

According to this embodiment, there is no risk that, after an assembly of the resin body 5, the resin body 5 will cause the locking of the rotation to the rotation shaft and it will be broken. Further, it is possible to readily assemble a device and to obtain an improved productivity in any trouble-free state.

The resin body varies in its frictional area by using more number of grease grooves 21 or less number of such grease grooves 21. It is, therefore, possible to readily obtain a required feeling of resistance by varying the number of grease grooves 21.

(Fourth Embodiment)

A hinge according to a fourth embodiment of the present invention will be described below by referring to FIG. 7. In this embodiment, eight grease grooves are formed in the inner surface of a bearing hole of a frictional resin body 5 and the lengths of the grease grooves 21 are alternately shortened on the reduced-diameter side of a tapered inner surface of the resin body 5. The remaining structure of the present invention is similar to that of the previously described embodiment of the present invention.

In this embodiment, the grease grooves 21 are formed in an as-uniform-as-possible way over a whole inner tapered surface of the bearing hole of the resin body 5. As a result, it is possible to uniformly distribute the grease and to obtain a frictional resin body 5 of added strength throughout.

(Fifth Embodiment)

A hinge according to a fifth embodiment of the present invention will be described below by referring to FIG. 8. In this embodiment, grease grooves 21 of shorter lengths are formed, in a distributed way, in the inner surface of a bearing hole of a frictional resin body 5. The remaining structure of this embodiment is similar to that of the first embodiment of the present invention.

Even in this embodiment, the grease grooves 21 are located, in an as-uniform-as-possible way, in the tapered inner surface of the bearing hole of the frictional resin body 5. As a result, the grease can be uniformly distributed over the surface and the strength of the resin body is uniformly distributed throughout.

(Sixth Embodiment)

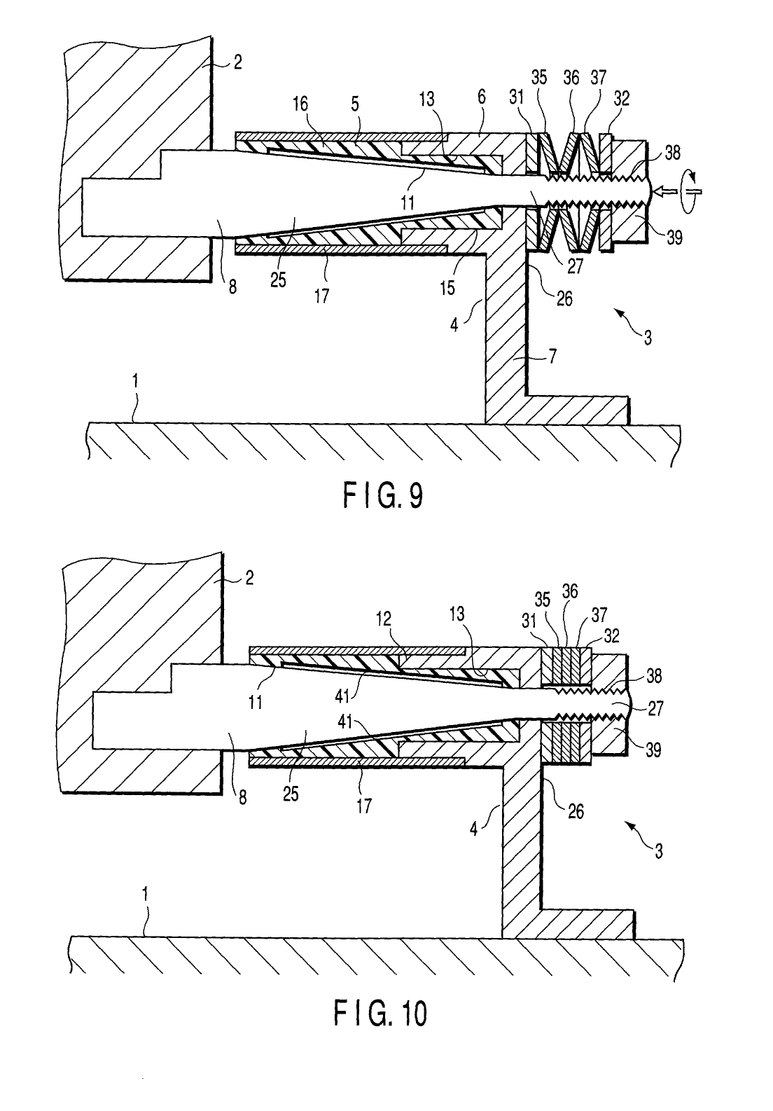

A hinge according to a sixth embodiment of the present invention will be described below by referring to FIGS. 9 to 12. Many component parts or portions of this embodiment are formed in a similar form to those of the first embodiment. Therefore, the same reference numerals are employed to designate the corresponding parts or portions and any further explanation is, therefore, omitted.

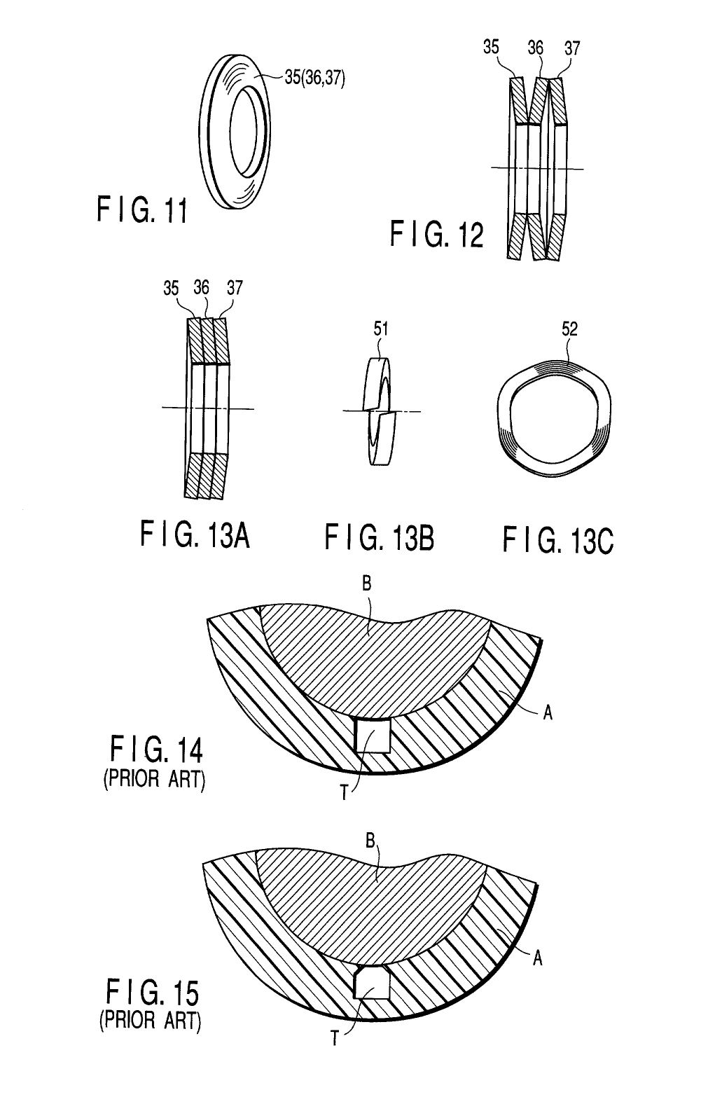

A tapered diameter-reduced end portion of a rotation shaft 8 supported by a frictional resin body 5 extends through a retaining section 6 from the frictional body 5 and further extends out of a rear surface 26 of the retaining section 6. A body fixing washer 31 and rotation washer 32 are fitted over the extending forward end portion 27. A spring member is elastically compressed between these washers 31 and 32. Here, as the spring member use is made of one or a requisite number of coned disk springs 35, 36 and 37 arranged in a mutually superimposed array, noting that the spring or springs constitute a seat spring each. These conical springs washer 35, 36 and 37 are arranged between the washers 31 and 32 in a series-combined array shown in FIG. 12.

Incidentally, the washers 31 and 32 are made of normally a sheet-like metal, but may be made of a relatively strong, hard resin. The springs 35, 36 and 37 as the spring member are made of spring steel.

A threaded section 38 is formed on the forward end portion 28 of the rotation shaft 8 and a tightening nut 39 is threaded on the threaded section 38. By doing so, a tightening means is constituted by which the rotation shaft 8 is tightened to the frictional resin body 5. By threading the nut 39 over the threaded section 38 of the rotation shaft 8, the rotation shaft 8 is strongly drawn toward the nut 39 side, so that the tapered peripheral surface of the rotation shaft 8 is pressed in a tightened state against the tapered inner surface of the bearing hole 15 of the frictional body 5.

When the nut 39 is tightened, the disk springs 35, 36 and 37 are compressed between the washers 31 and 32 and elastically deformed. As a result, as shown in FIG. 10, these disk springs are brought to a wholly tightly contacted, flattened, and superimposed state. When these springs 35, 36 and 37 are compressed to the wholly tightened contacted, flattened and superimposed state, a total reaction force (spring force) becomes maximal. Normally, the springs are tightened to an extent exceeding this state and a screw tightening force of the rotation shaft 8 against the frictional body 5 is set to, for example, 120% exceeding a total reaction force (spring force) of these springs 35, 36 and 37. Assembly is made in this state.

FIG. 10 shows a state tightened by the nut 39 after the assembling of the hinge 3 as shown in FIG. 9. At this time, the total reaction force (spring force) of the springs 35, 36, 37 may be in a range of 70 to 100% of the screw tightening pressure of the rotation shaft 8 against the frictional body 5, in particular, in a range of 90 to 100%. That is, it is preferable that, if 7 kg of a tightening pressure is exerted on the nut 39, then the total reaction force (spring force) of these springs 35, 36 and 37 be set from 6 kg to 7 kg. For this reason, use may be made of a conical spring which generates a spring force of from 2 kg to 2.7 kg per piece.

It may be added that, by properly adjusting the tightening force of the nut 39, the springs 35, 36 and 37 may be stopped to a tightened position preceding their final deformation end and then the total reaction force (spring force) be adjusted. In this case, the total reaction force (spring force) of these springs 35, 36 and 37 becomes a tightening force of the rotation shaft 8 against the frictional body 5.

The fixed washer 31 is pushed against a rear end 26 of the retaining section 6 to provide an integral unit to the retaining section 6. Further, the rotation washer 32 is pushed against the tightening nut 39 to provide an integral unit to the rotation shaft 8. As a result, it is rotated together with the rotation shaft 8. That is, normally, the fixing washer 31 is fixed to the retaining section 6 and the rotation washer 32 is rotated together with the rotation shaft 8, so that a slip occurs between each of the disk springs 35, 36 and 37 interposed between the washers 31 and 32 and also a slip occurs between the washers 31 and 32 to allow a rotation of the rotation shaft 8.

The frictional resin body 5 is one-piece molded and, normally, a molding material used is molded at 60 to 80°. According to the present invention, use is made of a molding material whose molding temperature is as high as 160° and hence a product reveals a high temperature resistance.

Where, however, the hinge 3 is exposed to a high temperature, for example, a product obtained is left for a longer time period in a car in the summer season, a frictional body 5 of a plastics molded article becomes high temperature. Under such a situation, if the tightening force is not elastically exerted by the disk springs 35, 36 and 37 on the rotation shaft 8, the frictional body 5 is deformed under an exposure to high temperature or the material used is weakened. If this is the case, then the reaction force of the frictional body 5 is weakened or a requisite rotational friction force is not obtained and there occurs the case that a loosening occurs between the associated parts.

According to the present invention, however, the springs 35, 36 and 37 are elongated to an extent corresponding to the weakening of a reaction force of the frictional body 5, thus compensating the tightening force exerted by the spring force on the rotation shaft 8. It is, therefore, possible to maintain a rotational friction force required. Stated in more detail, if, in order to provide a required feeling of resistance on the hinge 3 thus assembled as shown in FIG. 10, the shaft 8 is tightened by the nut 39 to an extent corresponding to from 0.6 mm to 0.8 mm, then the hinge provides a feeling of resistance of about 7 kg/fcm (rotational friction stress required).

If the frictional body 5 of the plastics molded product is exposed to high temperature for a longer period of time, then there is sometimes the case that its rotational friction stress (7 kg/fcm) required will be lowered. If, in this case, the nut is tightened to an extent corresponding to from about 0.1 mm to 0.3 mm, the feeling of resistance is restored. Since, however, the hinge 3 is covered with a cover of the molded product and incorporated within the article, the situation is such that it is not readily possible to perform a re-tightening operation.

If, according to this embodiment, however, the frictional body 5 is weakened, the compressed springs 35, 36 and 37 are elongated to an extent corresponding to a width of 1.5 mm exceeding an adjusting width required for tightening to allow an automatic compensation of the weakened tightening force. As a result, a requisite rotational friction force of the hinge 3 is maintained semipermanently without being lowered and, normally, any readjusting operation is unnecessary. Further, no inconvenience is involved even in the case where the tightening nut 39 is fixedly crimped to the rotation shaft 8. Since the readjusting operation is not necessary, more durability and reliability of the article are insured.

Further, according to such a hinge 3, a feeling of resistance can be secured by a surface pressure between the rotation shaft 8 and the frictional body 5 of all plastics molded product, a smooth rotation is not varied semipermanently. The hinge of this invention ensures a stabler function without lowering the requisite rotational friction stress and the reliability of the article can be improved. Even if, for example, the molded article is exposed to high temperature for a longer period of time in a car, etc., in the summer season and the frictional body of the molded article is degenerated and weakened, it is possible to maintain a requisite rotational friction force ensuring a smooth rotational operation under a given feeling of resistance and to insure a requisite rotational friction force.

For example, the array of springs 35, 36 and 37 may be arranged in a parallel array as shown in FIG. 13A. If such a parallel array is used, then a variation width becomes smaller than the array of the disk springs set out in connection with the embodiment first set out above. As the spring member, use may be made of a spring washer 51 as shown in FIG. 13B or a wave washer 52 as shown in FIG. 13C. Further, use may be made of any proper combination of various kinds of spring members or those having a different spring characteristic.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hinge comprising:
a frictional body made of resin and having an elongated bearing hole with a tapered inner surface and a center line and at least one lubricant groove cut in the tapered inner surface, having an opening and configured to hold lubricant;
a rotation shaft having a tapered peripheral surface and inserted in the bearing hole of the frictional body;
a tightening tool which moves the rotation shaft and the frictional body relative to each other, thereby to hold the shaft tightly in the bearing hole,
wherein the lubricant groove remains open even when the tapered inner surface is deformed as the shaft exerts a pressing force on the tapered inner surface.

2. A hinge according to claim 1, wherein the transverse cross-sectional shape of the lubricant oil groove is formed to have a substantially V shape.

3. A hinge according to claim 1, wherein the transverse cross-sectional shape of the lubricant oil groove is defined to be made W>H where W denotes the opening width of the oil groove and H denotes the depth of the oil groove.

4. A hinge according to claim 1, wherein the lubricant oil groove is formed to have an elongated shape, the longitudinal direction of the elongated groove being located along the inner surface of the bearing hole at an angle relative to the center line of the frictional resin body.

5. A hinge according to claim 1, further comprising a metal collar tightly fitted on the outer periphery of the frictional resin.

6. A hinge according to claim 2, wherein the transverse cross-sectional shape of the lubricant oil groove has its opening angular edges radiused.

7. A hinge according to claim 2, wherein the lubricant oil groove is formed to have an elongated shape, the oil groove being located along the inner surface of the bearing hole at an acute angle relative to the center line of the frictional resin body.

8. A hinge according to claim 3, wherein the transverse cross-sectional shape of the lubricant oil groove has its opening angular edges radiused.

9. A hinge comprising:
a frictional body made of resin and having an elongated bearing hole with a tapered inner surface and a center line and at least one lubricant groove cut in the tapered inner surface, having an opening and configured to hold lubricant;
a rotation shaft having a tapered peripheral surface and inserted in the bearing hole of the frictional body;
a tightening tool which moves the rotation shaft and the frictional body relative to each other, thereby to hold the shaft tightly in the bearing hole,
a spring member provided in a compressed state between the frictional body and the tightening tool;
wherein the lubricant groove remains open even when the tapered inner surface is deformed as the shaft exerts a pressing force on the tapered inner surface.

10. A hinge according to claim 9, further comprising:
a fixed washer arranged on a bearing body side and a rotation washer arranged on a rotation shaft side, wherein the spring member is located between the fixed washer and rotation washer

11. A hinge according to claim 9, further comprising a metal collar tightly fitted over the outer periphery of the frictional resin body.

12. A hinge according to claim 10, wherein the spring member is comprised of a seat spring, the seat spring being so located that the seat spring is tightened between the fixed washer and the rotation washer to a collapsed, flattened state.

13. A hinge comprising:
a frictional body made of resin and having an elongated bearing hole with a tapered inner surface and a center line and at least one lubricant groove cut in the tapered inner surface, having an opening and configured to hold lubricant;
a rotation shaft having a tapered peripheral surface and inserted in the bearing hole of the frictional body;
a tightening tool which moves the rotation shaft and the frictional body relative to each other, thereby to hold the shaft tightly in the bearing hole,
wherein the lubricant groove remains open even when the tapered inner surface is deformed as the shaft exerts a pressing force on the tapered inner surface, and the tightening tool includes a screw provided on the rotation shaft and a nut set in mesh with the screw.

14. A hinge according to claim 13, wherein the transverse cross-section shape of the lubricant oil groove is formed to have a substantially V shape.

15. A hinge according to claim 13, wherein the transverse cross-section shape of the lubricant oil groove is defined to be made W>H where W denotes the opening width of the oil groove and H denotes the depth of the oil groove.

16. A hinge according to claim 13, wherein the transverse cross-section shape of the lubricant oil groove has its opening angular edges radiused.

17. A hinge according to claim 13, wherein the lubricant oil groove has an elongated shape, the longitudinal direction of the elongated lubricant oil groove being located along the inner surface of the lubricant hole at an acute angle relative to the center line of the frictional body.

18. A hinge according to claim 13, wherein the lubricant oil groove is formed to have an elongated shape, the oil groove being located along the inner surface of the bearing hole at an angle relative to a center line of the frictional body.
